(19) United States
(12) Patent Application Publication
(10) Pub. No.: US 2016/0188208 A1
(43) Pub. Date: Jun. 30, 2016

(54) NONVOLATILE MEMORY SYSTEM AND OPERATION METHOD OF THE SAME

(71) Applicant: Samsung Electronics Co., Ltd., Suwon-si (KR)

(72) Inventors: Sang Gyun KIM, Suwon-si (KR); Kyu-Hyung KIM, Suwon-si (KR); Younwon PARK, Suwon-si (KR)

(21) Appl. No.: 14/965,995

(22) Filed: Dec. 11, 2015

(30) Foreign Application Priority Data
Dec. 24, 2014 (KR) 10-2014-0188106

(51) Int. Cl. G06F 3/06; G06F 12/02

(52) U.S. Cl. CPC G06F 3/061; G06F 12/0253; G06F 3/0679; G06F 3/0659; G06F 2212/7205

(57) ABSTRACT

An operation method of a nonvolatile memory system including a nonvolatile memory and a memory controller configured to control the nonvolatile memory includes receiving a write command including size information indicating a size of write data from an external device; determining whether or not garbage collection is being executed; executing the garbage collection for a first period of time based on the size information according to a result of the determination; and programming the write data into the nonvolatile memory after executing the garbage collection.

### CROSS-REFERENCE TO RELATED APPLICATIONS

This US non-provisional patent application claims priority under 35 USC §119 to Korean Patent Application No. 10-2014-0188106, filed on Dec. 24, 2014, the entirety of which is hereby incorporated by reference.

### BACKGROUND

1. Field

At least some example embodiments of the inventive concepts relate to semiconductor memories and, more particularly, to nonvolatile memory systems and an operation method of the same.

2. Related Art

A semiconductor memory device may include at least one semiconductor such as silicon Si, germanium Ge, gallium arsenide GaAs, indium phosphide InP, etc. A semiconductor memory device may be classified as a volatile semiconductor memory device or a nonvolatile semiconductor memory device.

A volatile memory device loses its stored data when its power supply is interrupted. Examples of the volatile memory device include a static RAM (SRAM), a dynamic RAM (DRAM), a synchronous DRAM (SDRAM), etc. A nonvolatile memory device retains its stored data even when its power supply is interrupted. Examples of the nonvolatile memory device include a read only memory (ROM), a programmable ROM (PROM), an electrically programmable ROM (EPROM), an electrically erasable and programmable ROM (EEPROM), a flash memory, a phase change RAM (PRAM), a magnetic RAM (MRAM), a resistive RAM (RRAM), a ferroelectric RAM (FRAM), etc.

Since flash memory devices have advantages such as high capacity and low noise, they have been widely used in a variety of applications. A flash memory device writes data in units of pages and performs an erase operation in units of memory blocks. Unlike a typical hard disk, many flash memory devices have a “write-after-erase” characteristic. That is, when a flash memory device writes data into previously programmed memory cells, the flash memory device writes the data after physically erasing the previously programmed memory cells. Various memory block management techniques have been used to compensate such physical characteristics of the flash memory device.

For example, some techniques include a memory controller configured to control a flash memory device to execute garbage collection (GC) to obtain a free block. The garbage collection is an operation that moves valid pages of victim blocks to a target block and erases the victim blocks to obtain a free block. When a free block is lacking during a write operation, a memory controller may execute garbage collection. However, since the garbage collection is executed by reading data of a valid page in a victim block, writing the read data into a target block, and erasing the victim block, it takes much time to execute the garbage collection. Moreover, when the garbage collection is executed while write data is programmed into a flash memory device, interleaving for the write data may not be maintained. Such garbage collection causes write performance of the flash memory device to be degraded.

### SUMMARY

An operation method of a nonvolatile memory system including a nonvolatile memory and a memory controller configured to control the nonvolatile memory includes receiving a write command including size information indicating a size of write data from an external device; determining whether or not garbage collection is being executed; executing the garbage collection for a first period of time based on the size information according to a result of the determination; and programming the write data into the nonvolatile memory after executing the garbage collection.

The method may further include transmitting a write completion response to the external device after the programming of the write data is completed.

The method may further include setting the first period of time such that the first period of time increases as the size of the write data increases.

The setting may include determining a length of the first period of time based on timeout time for the write command and a program time of the write data.

The timeout time may indicate a time defined by an interface between the external device and the memory controller, and the program time indicates a length of time of a programming operation for programming the write data into the nonvolatile memory.

The executing the garbage collection may include continuing to execute the garbage collection for the first period of time when the result of the determination indicates that the garbage collection is being executed.

The executing the garbage collection may include determining whether criteria for performing the garbage collection are met when the result of the determination indicates that the garbage collection is not being executed; and executing the garbage collection for the first period of time when the criteria are determined to be met.

The determining whether the criteria for performing the garbage collection are met may include determining whether a number of free blocks among a plurality of memory blocks included in the nonvolatile memory is smaller than a threshold value.

The garbage collection may include a plurality of operations, and the executing the garbage collection for the first period of time may include performing some of the plurality of operations of the garbage collection according to the result of the determination.

The plurality of operations may include selecting at least one victim block among a plurality of memory blocks of the nonvolatile memory; identifying one or more valid pages among a plurality of pages included in the selected at least one victim block to generate a valid table; selecting a target block among the plurality of memory blocks; moving data of the one or more valid pages to the target block based on the valid table; and erasing the selected at least one victim block.

The receiving the write command may include receiving the write command and the write data, and at least some of the write data is during the first period of time.

According to at least one example embodiment of the incentive concepts, a nonvolatile memory system comprises a nonvolatile memory including a plurality of memory blocks; and a memory controller configured to receive a write command including write data and size information of the write data from an external device, program the received write data into the nonvolatile memory, determine whether garbage collection is being executed when the write command is received, and execute the garbage collection based on the size information according to a result of the determination.

The memory controller programs the received write data into the nonvolatile memory after executing the garbage collection.

The memory controller transmits a write completion response to the external device after programming all the received write data.

The memory controller does not execute the garbage collection while programming the write data into the nonvolatile memory.

The memory controller executes the garbage collection for the predetermined time while receiving the write data.

The predetermined time increases as a size of the write data increases.

The garbage collection comprises an operation of selecting a victim block among a plurality of memory blocks included in the nonvolatile memory device by the memory controller; an operation of generating a valid table based on a valid page of the selected victim block by the memory controller; an operation of selecting a target block among the plurality of memory blocks by the memory controller; an operation of allowing data of the valid page of the victim block to migrate to the target block based on the generated valid table by the memory controller; and an operation of erasing the victim block by the memory controller, and the memory controller performs some of a plurality of operations included in the garbage collection for time according to the write command.

The memory controller transmits a device response to the external device in response to the write command to receive the write data from the external device.

### BRIEF DESCRIPTION OF THE DRAWINGS

The above and other features and advantages of example embodiments of the inventive concepts will become more apparent by describing in detail example embodiments of the inventive concepts with reference to the attached drawings. The accompanying drawings are intended to depict example embodiments of the inventive concepts and should not be interpreted to limit the intended scope of the claims. The accompanying drawings are not to be considered as drawn to scale unless explicitly noted.

FIG. 1 is a block diagram of a nonvolatile memory system according to at least some example embodiments of the inventive concepts.

FIG. 2 is a block diagram of a software layer of an external device and a nonvolatile memory device in FIG. 1.

FIG. 3 is a detailed block diagram of a memory controller in FIG. 1.

FIG. 4 is a detailed block diagram of the nonvolatile memory device in FIG. 1.

FIG. 5 is a flowchart summarizing the operation of a nonvolatile memory system according to at least some example embodiments of the inventive concepts.

FIGS. 6 and 7 illustrate an operating method in FIG. 5.

FIG. 8 is a block diagram of a nonvolatile memory system according to at least some example embodiments of the inventive concepts.

FIGS. 9 and 10 illustrate the operation of the nonvolatile memory system in FIG. 8.

FIG. 11 is a flowchart summarizing the operation of a nonvolatile memory system according to at least some example embodiments of the inventive concepts.

FIG. 12 is a timing diagram illustrating the operation of the nonvolatile memory system in FIG. 11.

FIG. 13 is a flowchart summarizing a garbage collection operation of a nonvolatile memory system.

FIGS. 14A to 14C illustrate the garbage collection operation in FIG. 13.

FIG. 15 is a block diagram of a memory card system to which a nonvolatile memory system according to at least some example embodiments of the inventive concepts is applied.

FIG. 16 is a block diagram of a solid state drive (SSD) system to which a nonvolatile memory system according to at least some of the inventive concepts is applied.

FIG. 17 is a block diagram of a user system to which a nonvolatile memory system according to at least some of the inventive concepts is applied.

### DETAILED DESCRIPTION

Detailed example embodiments of the inventive concepts are disclosed herein. However, specific structural and functional details disclosed herein are merely representative for purposes of describing example embodiments of the inventive concepts. Example embodiments of the inventive concepts may, however, be embodied in many alternate forms and should not be construed as limited to only the embodiments set forth herein.

Accordingly, while example embodiments of the inventive concepts are capable of various modifications and alternative forms, embodiments thereof are shown by way of example in the drawings and will herein be described in detail. It should be understood, however, that there is no intent to limit example embodiments of the inventive concepts to the particular forms disclosed, but to the contrary, example embodiments of the inventive concepts are to cover all modifications, equivalents, and alternatives falling within the scope of example embodiments of the inventive concepts. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the inventive concepts. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the inventive concepts. As used herein, the singular forms “a”, an and the are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Example embodiments of the inventive concepts are described herein with reference to schematic illustrations of idealized embodiments (and intermediate structures) of the inventive concepts. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

A nonvolatile memory system according to embodiments of inventive concepts may adjust execution time of garbage collection based on a write command received from a host. Thus, since the garbage collection is not performed during a program operation of nonvolatile memory devices included in the nonvolatile memory system, write performance of the nonvolatile memory system may be improved and timeout time for the write command may be satisfied. As a result, a nonvolatile memory system with improved performance and an operation method of the nonvolatile system may be provided.

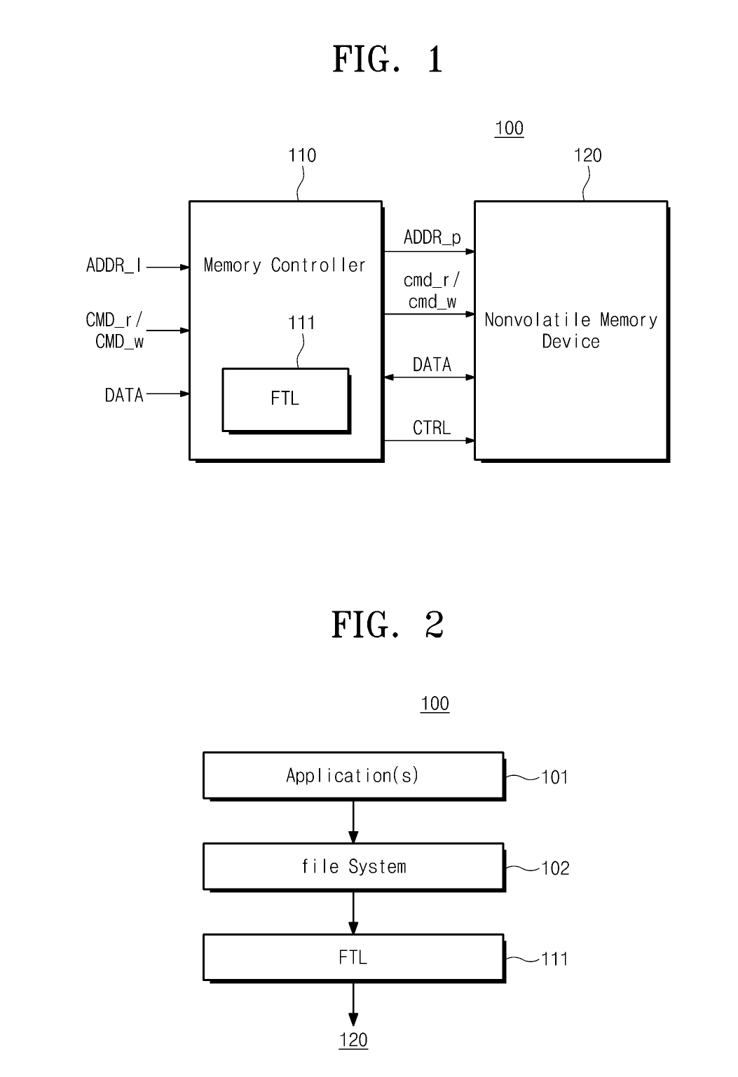

FIG. 1 is a block diagram of a nonvolatile memory system 100 according to at least some example embodiments of the inventive concepts. Referring to FIG. 1, the nonvolatile memory system 100 includes a memory controller 110 and a nonvolatile memory device 120. According to at least some example embodiments of the inventive concepts, each of the memory controller 110 and the nonvolatile memory device 120 may be implemented as circuits or circuitry included in a single chip, a single package or a single module. Alternatively, the memory controller 110 and the nonvolatile memory device 120 may be fabricated into a single chip, a single package or a single module to be provided as a storage device such as a memory card, a memory stick, and a solid state drive (SSD).

The nonvolatile memory system 100 may write data DATA or output the data DATA according to the control of an external device (e.g., a host, an application processor, etc.).

The memory controller 110 may receive a logical address ADDR_1, a read command CMD_r, and a write command CMD_w from an external device (e.g., a host, an application processor, etc.). The memory controller 110 may read data DATA written into the nonvolatile memory device 120 and output the read data DATA in response to the received read command CMD_r. Alternatively, the memory controller 110 may write the read data DATA into the nonvolatile memory device 120 in response to the received write command CMD_w.

For example, when the memory controller 110 receives the logical address ADDR_1 and the read command CMD_r from the external device, the memory controller 110 may transmit a physical address ADDR_p corresponding to the logical address ADDR_1, the read command cmd_r, and a control signal CTRL to the nonvolatile memory device 120. The nonvolatile memory device 120 may output data DATA stored in an area corresponding to the received physical address ADDR_p in response to received signals.

For example, when the memory controller 110 receives the logical address ADDR_1 and the write command CMD_w from the external device, the memory controller 110 may transmit the physical address ADDR_p corresponding to the logical address ADDR_1, a write command cmd_w, the control signal CTRL, and write data DATA to the nonvolatile memory device 120. The nonvolatile memory device 120 may write data DATA into an area corresponding to the received physical address ADDR_p in response to received signals.

According to at least some example embodiments of the inventive concepts, the read and write commands CMD_r and CMD_w transmitted between the external device and the memory controller 110 may be a command or a signal defined by an interface between the external device and the memory controller 110. According to at least some example embodiments of the inventive concepts, the read and write commands cmd_r and cmd_w transmitted between the memory controller 110 and the nonvolatile memory device 120 may be a command or a signal defined by an interface between the memory controller 110 and the nonvolatile memory device 120.

The nonvolatile memory device 120 may write data DATA or output stored data DATA according to the control of the memory controller 110. According to at least some example embodiments of the inventive concepts, the nonvolatile memory device 120 may include nonvolatile memories such as a NAND flash memory, a NOR flash memory, a PRAM, an MRAM, an FRAM, and a ReRAM. For brevity of description, hereinafter, it will be assumed that the nonvolatile memory device 120 is provided based on a NAND flash memory.

The memory controller 110 includes a flash translation layer (hereinafter referred to as “FTL”) 111. The FTL 111 may provide an interface between the external device and the nonvolatile memory device 120 to efficiently use the nonvolatile memory device 120. For example, the FTL 111 may translate a logical address ADDR_1 received from the external device into a physical address ADDR_p. The FTL 111 may perform the above-mentioned address translation operation through a mapping table. According to at least some example embodiments of the inventive concepts, the logical address ADDR_1 specifies a logical location of a storage area managed by the external device and the physical address ADDR_p specifies a physical location of the nonvolatile memory device 120 managed by the memory controller 110.

The FTL 111 may perform a background operation such as wear-leveling and garbage collection (GC) to efficiently use the nonvolatile memory device 120.

According to at least some example embodiments of the inventive concepts, the wear-leveling is an operation that manages program/erase counts of a plurality memory blocks included in the nonvolatile memory device 120 to equalize the program/erase counts of the memory blocks.

According to at least some example embodiments of the inventive concepts, the garbage collection is an operation that moves valid pages in some of a plurality of memory blocks to another memory block and erases some memory blocks. The erased memory blocks may be used as free blocks. The FTL 111 may execute the garbage collection to obtain free blocks.

According to at least some example embodiments of the inventive concepts, the garbage collection may be executed under a specific condition. For example, the FTL 111 may execute garbage collection when the number of free blocks of the nonvolatile memory device 120 is equal to or less than a reference value.

According to at least some example embodiments of the inventive concepts, the memory controller 110 may receive the write command CMD_w from the external device and write data DATA into the nonvolatile memory device 120 in response to the received write command CMD_w. The memory controller 110 may execute garbage collection to obtain free blocks when the number of free blocks of the nonvolatile memory device 120 becomes equal to or less than a reference value during a write operation. That is, write operations may not be sequentially performed as the memory controller 110 performs garbage collection during a write operation. Thus, write performance of the nonvolatile memory system 100 may be degraded.

The nonvolatile memory system 100 determines whether garbage collection is being executed, when receiving the write command CMD_w from the external device, and may execute the garbage collection based on the write command CMD_w received from the external device for a predetermined or, alternatively, desired time according to a result of the determination.

More specifically, the write command CMD_w received from the external device may include information on a size of write data to be written into the nonvolatile memory device 120, and the memory controller 110 may adjust execution time of garbage collection based on the information on the size of the write data included in the write command CMD_w. For example, according to at least one example embodiment of the inventive concepts, and end point of an execution of a garbage collection operation may be set by the memory controller 110 based on the size of the write data included in the write command CMD_w.

According to at least one example embodiment of the inventive concepts, a look up table (LUT) (e.g., included in the memory controller 110) generates the garbage collection execution time lengths based on a size of write data being written, for example, as indicated by the write command CMD_w. The LUT may receive the data size as an input and produce the execution length (or, alternatively, execution endpoint) as an output. Further, according to at least one example embodiment of the inventive concepts, the relationships between data sizes and corresponding garbage collection execution lengths defined by the LUT may be determined based on empirical study.

Thus, the execution time of the garbage collection is adjusted according to the write command CMD_w to prevent timeout of a write operation. Moreover, the nonvolatile memory device 120 may sequentially perform a write operation by executing garbage collection before data DATA is written into the nonvolatile memory device 120. Thus, write performance of the nonvolatile memory system 100 is improved.

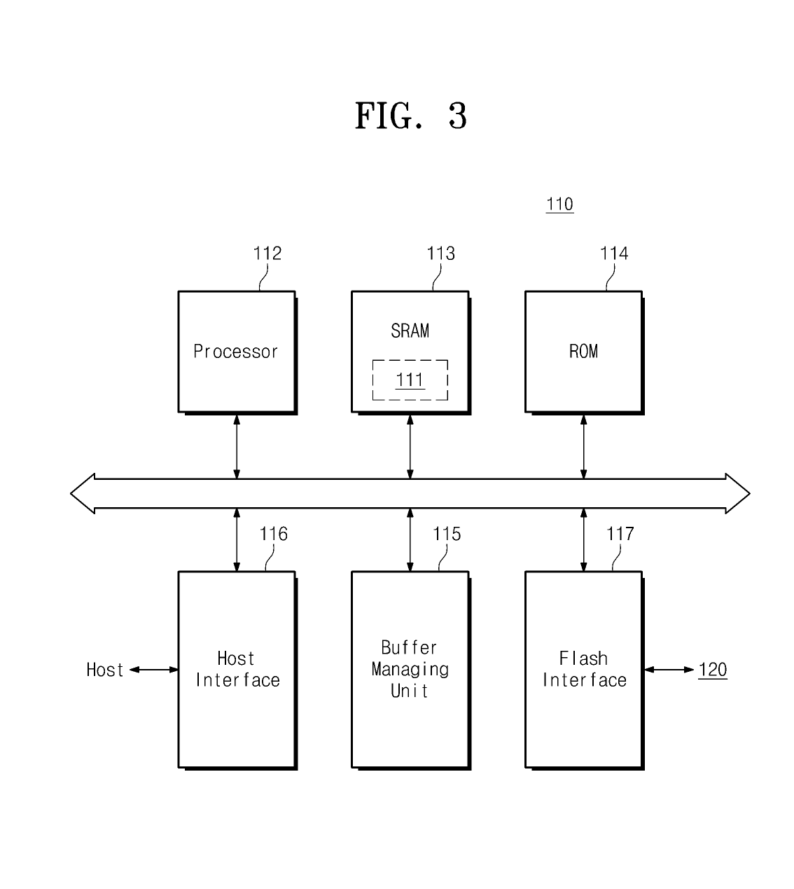

FIG. 2 is a block diagram of a software layer of an external device and the nonvolatile memory system in FIG. 1. Referring to FIGS. 1 and 2, according to at least one example embodiment of the inventive concepts, application(s) 101 and a file system 102 may be included in the external device.

The application(s) 101 may include various application programs driven in the external device. Data generated by driving the application 101 or data for driving the application 101 may be stored in the nonvolatile memory device 120.

The file system 102 serves to organize a file or data to be stored in the nonvolatile memory device 120. For example, the file system 102 may provide the memory controller 110 with a logical address ADDR_1 of a file or data to be stored in the nonvolatile memory device 120.

The file system 102 may have another form according to an operating system (OS) of the external device. According to at least some example embodiments of the inventive concepts, the file system 102 may include a File Allocation Table (FAT), FAT32, NT File System (NTFS), Hierarchical File System (HFS), Journaled File System2 (JSF2), XFS, On-Disk Structure-5 (ODS-5), UDF, ZFS, Unix File System (UFS), ext2, ext3, ext4, ReiserFS, Reiser4, ISO 9660, Gnome VFS, BFS or WinFS. According to at least some example embodiments of the inventive concepts, the application 101 and the file system 102 may be driven by an external device (e.g., a host, an application processor (AP), etc.).

The FTL 111 may translate a logical address ADDR_1 from the file system 102 into a physical address ADDR_p used in the nonvolatile memory device 120. The FTL 111 has been described with reference to FIG. 1 and will not be described in further detail.

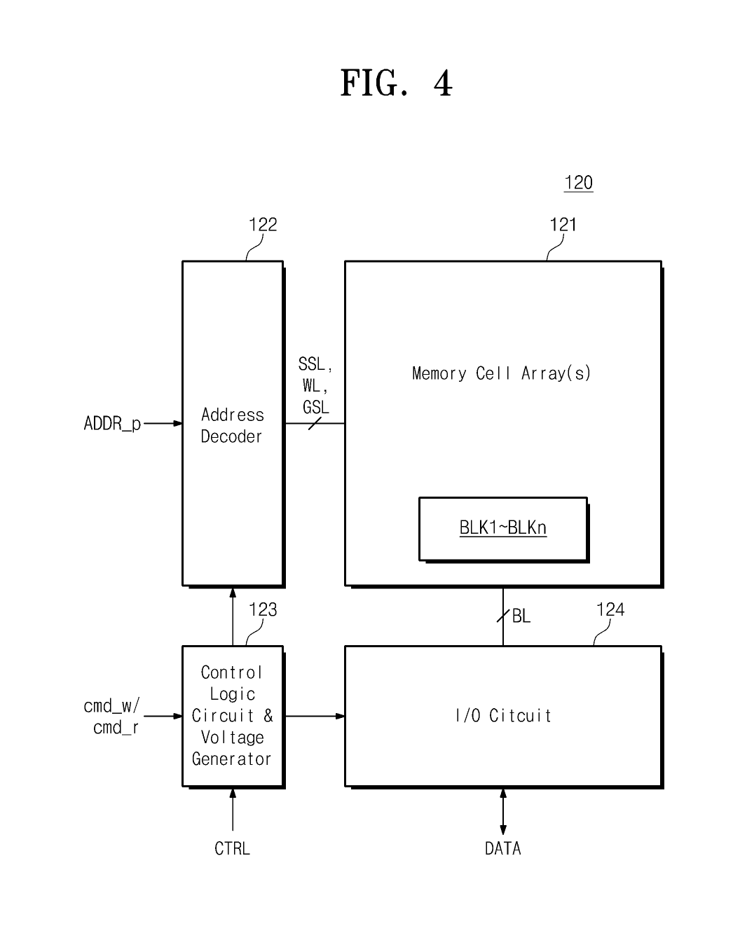

FIG. 3 is a detailed block diagram of the memory controller 110 in FIG. 1. Referring to FIGS. 1 and 3, the memory controller 110 includes a processor 112, an SRAM 113, a ROM 114, a buffer managing unit 115, a host interface 116, and a flash interface 117. According to at least one example embodiment, each of the processor 112, SRAM 113, ROM 114, buffer managing unit 115, host interface 116, and a flash interface 117 may be connected to, and communicate with each other through, a data bus.

The processor 112 may control the overall operation of the memory controller 110. The SRAM 113 may be used as a buffer memory, a cache memory or a working memory of the memory controller 110.

The term ‘processor’, as used herein, may refer to, for example, a hardware-implemented data processing device having circuitry that is physically structured to execute desired operations including, for example, operations represented as code and/or instructions included in a program. Examples of the above-referenced hardware-implemented data processing device include, but are not limited to, a microprocessor, a central processing unit (CPU), a processor core, a multi-core processor; a multiprocessor, an application-specific integrated circuit (ASIC), and a field programmable gate array (FPGA).

According to at least some example embodiments of the inventive concepts, the FTL 111 may be provided in the form of software. The FTL 111 provided in the form of software may be stored in the SRAM 113. The FTL 111 stored in the SRAM 113 may be driven by the processor 112.

The ROM 114 may store various information required or, alternatively, used for operating the memory controller 110 in the form of firmware.

The buffer managing unit 115 may manage a buffer memory of the memory controller 110. For example, the SRAM 113 may be used as the buffer memory of the memory controller 110. Data read from the nonvolatile memory device 120 may be temporarily stored in the SRAM 113. Alternatively, write data received from an external data (i.e., data to be written into the nonvolatile memory device 120) may be temporarily stored in the SRAM 113. Alternatively, the memory controller 110 may include a separate buffer memory (not shown) and the buffer managing unit 115 may manage the separate buffer memory. The buffer managing unit 115 may be implemented as software, hardware or a combination of software and hardware. For example, according to at least one example embodiment of the inventive concepts, the buffer managing unit 115 may be implemented as a circuit or circuitry specifically structured to perform the operations described herein as being performed by the buffer managing unit 115. Additionally, or alternatively, according to at least one example embodiment of the inventive concepts, the buffer managing unit 115 may be implemented by a processor (e.g., the processer 112) executing instructions (e.g., code of a program) corresponding to the operations described herein as being performed by the buffer managing unit 115.

According to at least some example embodiments of the inventive concepts, a data management unit of an external device may be different from that of a nonvolatile memory device 120. For example, the external device may manage data by a sector unit. That is, the external device may write and read data by a sector unit. Meanwhile, the nonvolatile memory device 120 may manage data by a page unit. That is, the nonvolatile memory device 120 may read and write data by a page unit. According to at least some example embodiments of the inventive concepts, the page unit may be greater than the sector unit. The buffer managing unit 115 may combine the sector-unit data DATA received from an external device to create page units such that the received data DATA is written into the nonvolatile memory device 120 in page units during a write operation.

The memory controller 110 may communicate with an external device via the host interface 116. According to at least some example embodiments of the inventive concepts, the host interface 116 may include at least one of various interfaces such as Universal Serial Bus (USB), multimedia card (MMC), embedded MMC, peripheral component interconnection (PCI), PCI-express, Advanced Technology Attachment (ATA), Serial-ATA, Parallel-ATA, small computer small interface (SCSI), enhanced small disk interface (ESDI), Integrated Drive Electronics (IDE), Firewire, and Universal Flash Storage (UFS).

The memory controller 110 may communicate with the nonvolatile memory device 120 via the flash interface 117. According to at least some example embodiments of the inventive concepts, the flash interface 117 may include a NAND interface.

According to at least some example embodiments of the inventive concepts, the write and read commands CMD_w and CMD_r received from the external device may be a command or a signal defined by the host interface 116. According to at least some example embodiments of the inventive concepts, the write and read command cmd_w and cmd_r provided to the nonvolatile memory device 120 from the memory controller 110 may be a command or a signal defined by the flash interface 117.

The host interface 116 may be implemented as software, hardware or a combination of software and hardware. For example, according to at least one example embodiment of the inventive concepts, the host interface 116 may be implemented as a circuit or circuitry specifically structured to perform the operations described herein as being performed by the host interface 116. Additionally, or alternatively, according to at least one example embodiment of the inventive concepts, the host interface 116 may be implemented by a processor (e.g., the processer 112) executing instructions (e.g., code of a program) corresponding to the operations described herein as being performed by the host interface 116.

The flash interface 117 may be implemented as software, hardware or a combination of software and hardware. For example, according to at least one example embodiment of the inventive concepts, the flash interface 117 may be implemented as a circuit or circuitry specifically structured to perform the operations described herein as being performed by the flash interface 117. Additionally, or alternatively, according to at least one example embodiment of the inventive concepts, the flash interface 117 may be implemented by a processor (e.g., the processer 112) executing instructions (e.g., code of a program) corresponding to the operations described herein as being performed by the flash interface 117.

Although not shown in the drawings, the memory controller 110 may further include components such as a randomizer (not shown) configured to randomize data and an error correction circuit (not shown) configured to correct a data error. The randomizer may implemented as software, hardware or a combination of software and hardware.

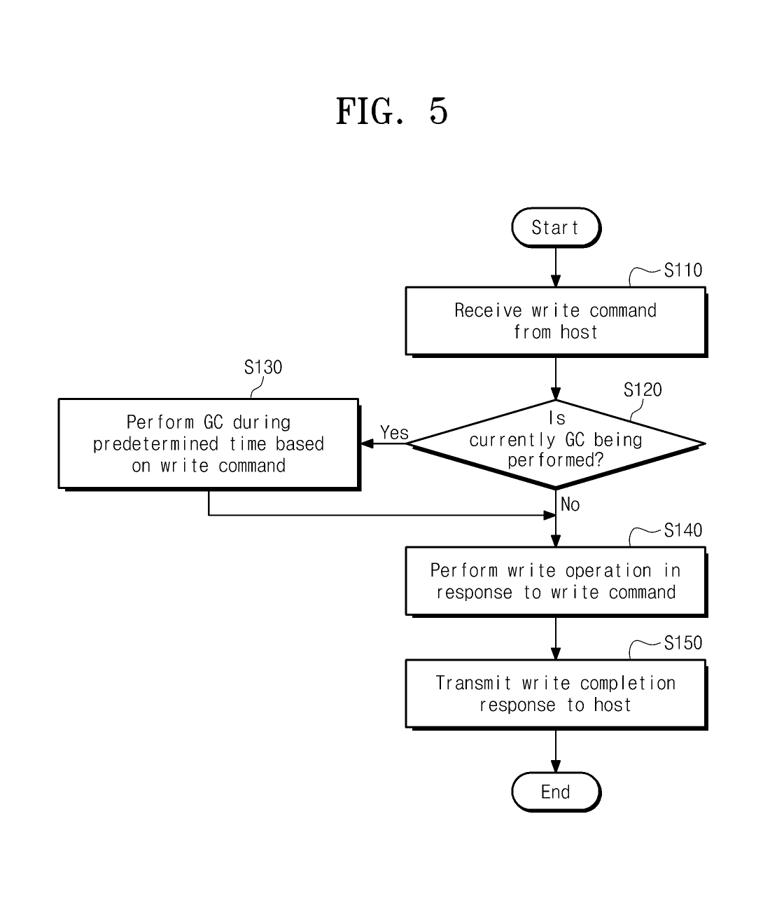

FIG. 4 is a detailed block diagram of the nonvolatile memory device 120 in FIG. 1. Referring to FIGS. 1 and 4, the nonvolatile memory device 120 includes a memory cell array 121, an address decoder 122, a control logic and voltage generator block 123, and an input/output (I/O) circuit 124. The address decoder 122 and a control logic and voltage generator block 123 may be implemented, for example, as circuits or circuitry.

The memory cell array 121 includes a plurality of memory blocks BLK1 to BLKn. Each of the memory blocks BLK1 to BLKn includes a plurality of cell strings. Each of the cell strings includes a plurality of memory cells. The memory cells are connected to a plurality of wordlines WL, respectively. Each of the memory cells may include a single-level cell (SLC) storing a single bit or a multi-level cell (MLC) storing at least two bits.

The address decoder 122 is connected to the memory cell array 121 through a plurality of wordlines WL, string selection lines SSL, and ground selection lines GSL. The address decoder 122 may receive a physical address ADDR_p and decode the received physical address ADDR_p to select at least one of the wordlines WL. The address decoder 122 may control a voltage of the selected wordline.

The control logic and voltage generator block 123 may receive write and read commands (cmd_w and cmd_r) and a control signal. The control logic and voltage generator block 123 may control the address decoder 122 and the I/O circuit 124 to write data DATA into the memory cell array 121 or read data DATA written into the memory cell array 121 in response to received signals.

The control logic and voltage generator block 123 may generate various voltages used by the nonvolatile memory device 120. For example, the control logic and voltage generator 123 may generate various voltages such as a plurality of selected read voltages, a plurality of unselected read voltages, a plurality of program voltages, a plurality of pass voltages, a plurality of erase voltages, a plurality of sampling voltages.

The I/O circuit 124 is connected to the memory cell array 122 through a plurality of bitlines BL. The I/O circuit 124 may control a voltage of the bitlines BL to write the received data DATA into the memory cell array 121. Alternatively, the I/O circuit 124 may control the bitlines BL to read data DATA stored in the memory cell array 121 according to the control of the control logic and voltage generator block 123.

According to at least some example embodiments of the inventive concepts, the I/O circuit 124 may include components such as a page buffer (or page register), a column select circuit, a data buffer, and a global buffer. According to at least some example embodiments of the inventive concepts, the I/O circuit 124 may include components such as a sense amplifier, a write driver, a column select circuit, and a data buffer.

In at least one example embodiment of the inventive concepts, a three dimensional (3D) memory array is provided. The 3D memory array is monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array.

In at least one example embodiment of the inventive concepts, the 3D memory array includes vertical NAND strings that are vertically oriented such that at least one memory cell is located over another memory cell. The at least one memory cell may comprise a charge trap layer. Each vertical NAND string may include at least one select transistor located over memory cells, the at least one select transistor having the same structure with the memory cells and being formed monolithically together with the memory cells.

The following patent documents, which are hereby incorporated by reference, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587; 8,559,235; and US Pat. Pub. No. 2011/0233648.

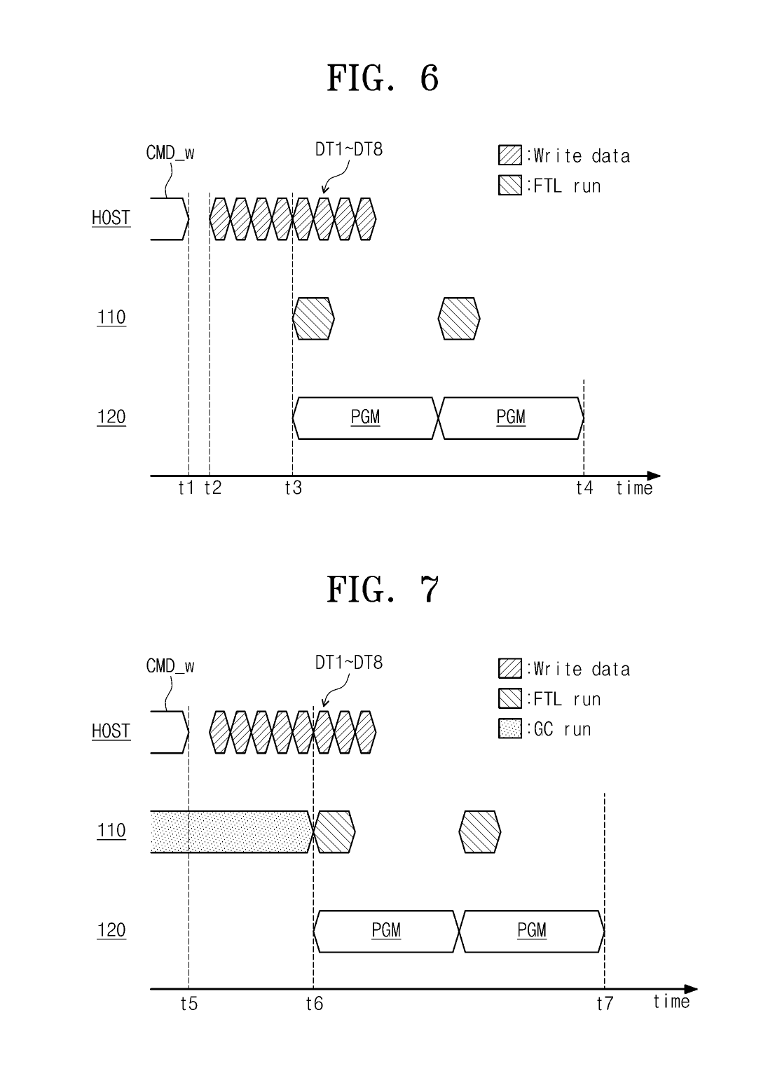

FIG. 5 is a flowchart showing the operation of a nonvolatile memory system according to at least some example embodiments of the inventive concepts. Hereinafter, for brevity of description, an operation of storing data by the nonvolatile memory system 100 according to a write command CMD_w of an external device will be referred to as a “write operation”, and an operation of storing write data by the nonvolatile memory device 120 according to the control of the memory controller 110 will be referred to as a “program operation”. That is, a write operation is performed once on a single write command CMD_w and the write operation performed once includes a plurality of program operations. However, example embodiments are not limited thereto.

Referring to FIGS. 1 and 5, in a step S110, the memory controller 110 receives a write command CMD_w from an external device (hereinafter referred to as “host”). According to at least some example embodiments of the inventive concepts, the write command CMD_w may be a command or a signal defined by an interface between the memory controller 110 and the host. The write command CMD_w may include information on size of write data to be written into the nonvolatile memory device 120.

In a step S120, the memory controller 110 determines whether the memory controller 110 is currently executing garbage collection. For example, before the step S110, the memory controller 110 may execute the garbage collection under a specific condition. According to at least some example embodiments of the inventive concepts, the specific condition may include a case where the number of free blocks of the nonvolatile memory device 120 is smaller than a reference value.

When a result of the determination indicates that the memory controller 110 is currently executing the garbage collection, in a step S130, the memory controller 110 may control garbage collection currently being performed such that the garbage collection is performed for a predetermined or, alternatively, desired time based on the write command CMD_w.

More specifically, the write command CMD_w may include the information on a size of data to be written into the nonvolatile memory device 120. Timeout time for a write operation may vary depending on the information on a size of the write data. The memory controller 110 may adjust execution time of the garbage collection based on timeout time depending on the information on a size of the write data and program time actually required to write the write data into the nonvolatile memory device 120.

According to at least some example embodiments of the inventive concepts, the timeout time may include time from receiving the write command CMD_w by the memory controller 110 to transmitting a write response to the host by the memory controller 110 when a write operation is completed. Alternatively, the timeout time may include time from starting to the write data by the memory controller 110 to transmitting a write completion response to the host by the memory controller 110 when a write operation is completed.

The program time actually required to the write data into the nonvolatile memory device 120 includes time required to perform a program operation by the nonvolatile memory device 120.

Hereinafter, for brevity of description, timeout time is time from receiving the write command CMD_w to transmitting the write completion response to the host by the memory controller 110 when the write operation is completed. However, example embodiments are not limited thereto.

When the result of the determination indicates that the memory controller 110 is not executing the garbage collection or the step S130 is completed, in step S140, the memory controller 110 may perform a write operation in response to the write command CMD_w. For example, the memory controller 110 may receive the write data from the host after receiving the write command CMD_w. The memory controller 110 may write the received write data into the nonvolatile memory device 120. According to at least some example embodiments of the inventive concepts, the nonvolatile memory device 120 may perform program operations on the write data according to the control of the memory controller 110.

In a step 150, after the write data is all written, the memory controller 110 transmits the write completion response to the host. According to at least some example embodiments of the inventive concepts, a time point at which the write completion response is transmitted is not limited to the above. For example, the memory controller 110 may transmit the write completion response to the host within a predetermined or, alternatively, desired time after receiving all the write data. The predetermined or, alternatively, desired time may be time predefined or, alternatively, defined by an interface between the host and the memory controller 110.

According to the foregoing embodiments, the memory controller 110 may adjust execution time of garbage collection that is being executed based on the write command CMD_w. Thus, timeout time for a write command may be satisfied. Moreover, since the garbage collection is not executed while data is written into the nonvolatile memory device 120, write performance of the nonvolatile memory system is improved.

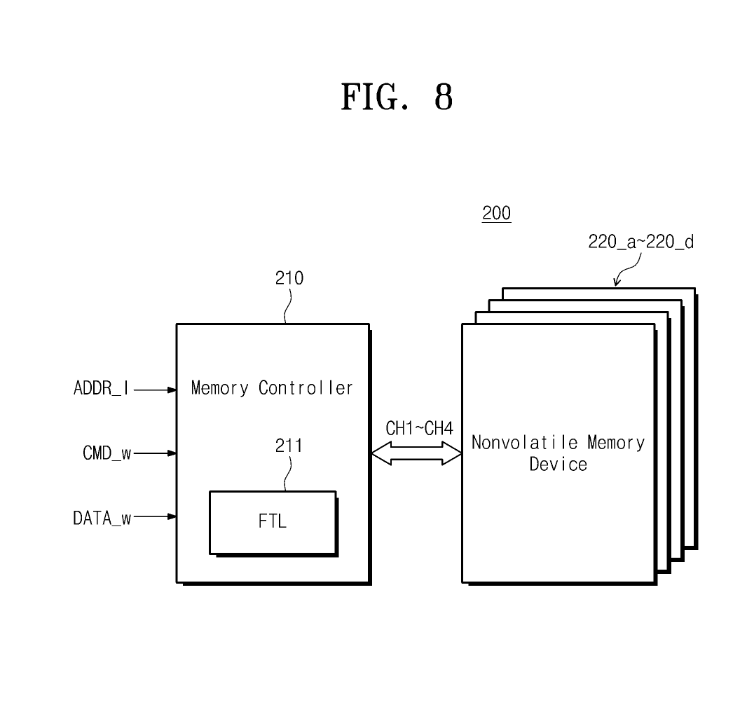

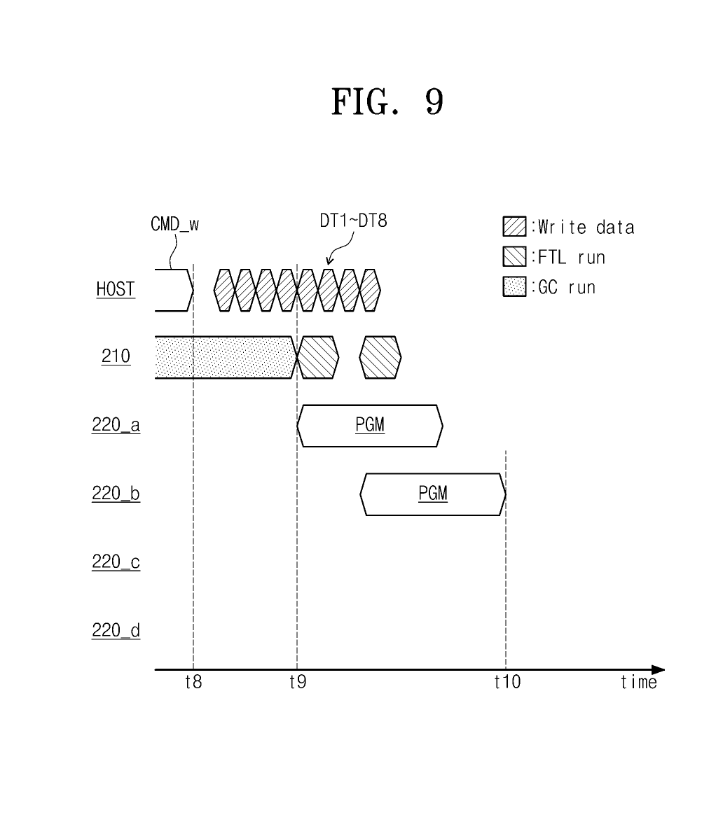

FIGS. 6 and 7 illustrate the operating method in FIG. 5. For brevity of description, FIGS. 6 and 7 do not show signals or components that are unnecessary for describing the operation of the memory controller 110 according to at least some example embodiments of the inventive concepts. However, example embodiments are not limited thereto.

In addition, for brevity of description, an example will be described where a unit of data received from the host is a sector unit and a unit of data programmed into the nonvolatile memory device 120 is a page unit. In the example, one page of data includes four sectors of data. However, at least some example embodiments of the inventive concepts are not limited thereto and various data units may be used.

According to at least some example embodiments of the inventive concepts, the operation described with reference to FIG. 6 may include operations S110, S120, S140, and S150.

Referring to FIGS. 1 and 6, at first time point t1, the memory controller 110 may receive the write command CMD_w from the host. At this point, the memory controller 110 may determine whether garbage collection is being executed.

As illustrated in FIG. 5, when the garbage collection is not being performed at first time point t1, the memory controller 110 may start to receive write data DT1 to DT8 at second time point t2. According to at least some example embodiments of the inventive concepts, the memory controller 110 may sequentially receive the write data DT1 to DT8.

According to at least some example embodiments of the inventive concepts, although not shown in FIG. 5, the memory controller 110 may transmit a device response to the write command CMD_w at any time between the first time point t1 and the second time point t2. The host may sequentially transmit the write data DT1 to DT8 to the memory controller 110 in response to the device response from the memory controller 110.

At third time point t3, the first to fourth write data DT1 to DT4 may be received. At this point, the memory controller 110 may perform a series of operations to write the first to fourth write data DT1 to DT4 into the nonvolatile memory device 120. For example, the FTL 111 of the memory controller 110 may perform an address translation operation to designate physical addresses where the first to fourth write data DT1 to DT4 are to be written. The nonvolatile memory device 120 may program the first to fourth write data DT1 to DT4 under the control of the memory controller 110. To put it another way, the nonvolatile memory device 120 may perform a program operation on the first to fourth write data DT1 to DT4 according to the control of the memory controller 110.

After the program operation of the nonvolatile memory device 120 performed on the first to fourth write data is completed, the memory controller 110 may perform a series of operations to write the fifth to eighth write data DT5 to DT8 into the nonvolatile memory device 120. For example, the FTL 111 of the memory controller 110 may perform an address translation operation to designate physical locations where the fifth to eighth data DT1 to DT8 are to be written. The nonvolatile memory device 120 may store the fifth to eighth data DT5 to DT8 under the control of the memory controller 110. To put it another way, the nonvolatile memory device 120 may perform a program operation on the fifth to eighth data DT5 to DT8.

At time point t4, at which the program operation of the nonvolatile memory device 120 performed on the fifth to eighth data DT5 to DT8 is completed, the memory controller 110 may transmit a write completion response to the host.

According to at least some example embodiments of the inventive concepts, the write data DT1 to DT8 received from the host may be temporarily stored in a buffer memory assigned to the host interface 116 (see FIG. 2). The temporarily stored write data DT1 to DT8 may be partitioned or managed in units of pages by the buffer managing unit 115 (see FIG. 2).

Referring to FIGS. 1, 5, and 7, the memory controller 110 may receive the write command CMD_w from the host at fifth time point t5. At this point, the memory controller 110 may determine whether garbage collection is currently being executed. As illustrated in FIG. 7, the memory controller 110 may be executing the garbage collection at the fifth time point t5. In this case, the memory controller 110 may execute the garbage collection for execution time based on the received write command CMD_w.

For example, the write command CMD_w may include information on a size of write data to be written into the nonvolatile memory device 120. Timeout time of a write operation of the nonvolatile memory device may vary depending on the information included in the write command CMD_w. The memory controller 110 may determine execution time at which the garbage collection is to be executed based on the timeout time and program time.

More specifically, timeout time for a write operation of data of 32 KB may be 10 ms and program time for the data of 32 KB may be 70 ms. In this case, the memory controller 110 may execute garbage collection for 30 ms. Alternatively, timeout time for a write operation of data of 128 KB may be 200 ms and program time for write data of 128 KB may be 150 ms. In this case, the memory controller 110 may execute garbage collection for 50 ms. The above-mentioned times and numerical values are merely examples to aid understanding, and at least some example embodiments of the inventive concepts are not limited thereto.

According to at least some example embodiments of the inventive concepts, timeout time depending on the information on a size of write data may be predetermined or, alternatively, desired time. Alternatively, a value of a timeout time may be based on a size of write data and a host interface between a host and a memory controller. According to at least some example embodiments of the inventive concepts, a value of a program time may be based on a size of write data and a program speed of the nonvolatile memory 120. According to at least one example embodiment of the inventive concepts, the memory controller 110 may determine a program speed of the nonvolatile memory 120, and the memory controller 110 may determine that timeout time based on an size of data to be programmed and the determined program speed of the nonvolatile memory 120.

According to at least some example embodiments of the inventive concepts, the memory controller 110 may sequentially receive the write data DT1 to DT8 from the host while executing the garbage collection is executed after receiving the write command CMD_w. That is, the memory controller 110 may execute the garbage collection and receive write data concurrently for a predetermined or, alternatively, desired time after receiving the write command CMD_w.

After executing the garbage collection for the predetermined or, alternatively, desired time (or execution time based on the write command CMD_w), the memory controller 110 may perform a series of operations to write the first to eighth write data DT1 to DT8 into the nonvolatile memory device 120 at sixth time point t6. The program operation performed on the first to eighth write data DT1 to DT8 has been described with reference to FIG. 6 and will not be described in further detail. Accordingly, an execution time of the garbage collection operation may be set by the memory controller 110 based on information included in the write command CMD_w. Further, a location of an endpoint of the garbage collection operation (e.g., time point t6 in FIG. 7) may be set by the memory controller 110 based on information included in the write command CMD_w.

After the program operation performed on the first to eighth write data DT1 to DT8 is completed, the memory controller 110 may transmit a write completion response to the host at seventh time point t7.

As described above, the nonvolatile memory system 100 according to at least some example embodiments of the inventive concepts may perform garbage collection for predetermined or, alternatively, desired time based on a received write command CMD_w. In further detailed example embodiments, the memory controller 110 may adjust execution time of garbage collection based on size information of write data included in the write command CMD_w. Thus, write performance of the nonvolatile memory system 100 is improved.

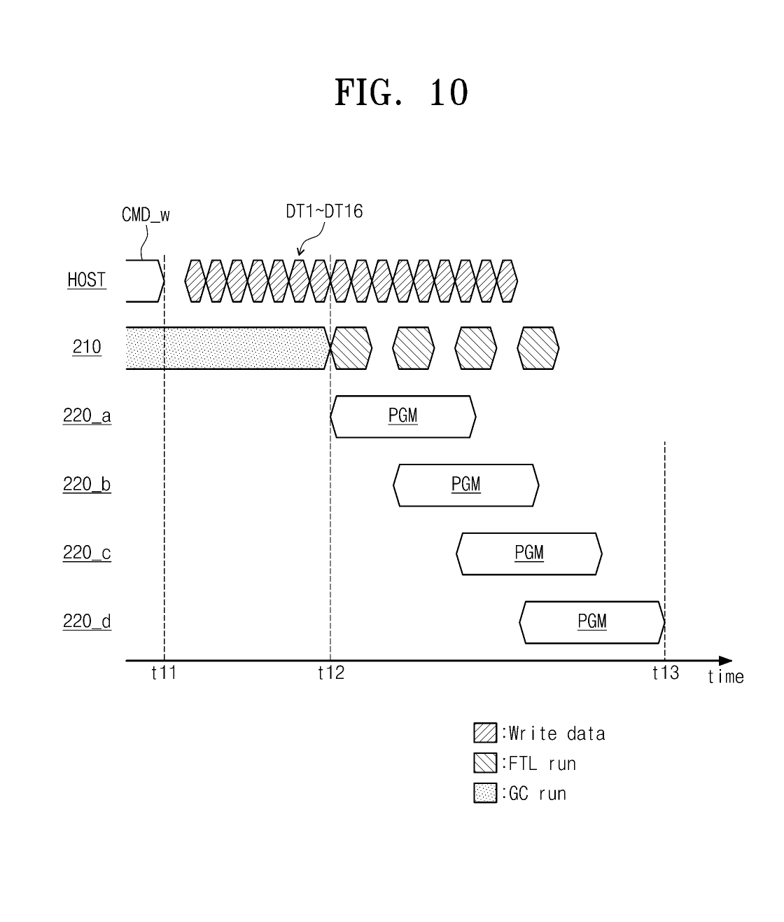

FIG. 8 is a block diagram of a nonvolatile memory system according to at least some example embodiments of the inventive concepts. As illustrated, the nonvolatile memory system 200 includes a memory controller 210 and first to fourth nonvolatile memory devices 220_a to 220_d. The memory controller 210 may have the same structure and operation as that described above with respect to the memory controller 110 and will not be described in further detail.

Each of the first to fourth nonvolatile memory devices 220_a to 220_d may be the nonvolatile memory device 120 described with reference to FIGS. 1 to 4. The first to fourth nonvolatile memory devices 220_a to 220_d may be connected to the memory controller 210 through first to fourth channels CH1 to CH4, respectively and may operate independently according to the control of the memory controller 210. For example, a plurality of nonvolatile memory devices 220_a to 220_d may program different data at the same time. According to at least some example embodiments of the inventive concepts, a plurality of nonvolatile memory devices 220_a to 220_d may include separate chips, respectively and may be provided to a multichip package (MCP).

According to at least some example embodiments of the inventive concepts, the nonvolatile memory system 200 may further include nonvolatile memory devices other than the first to fourth nonvolatile memory devices 220_a to 220_d.

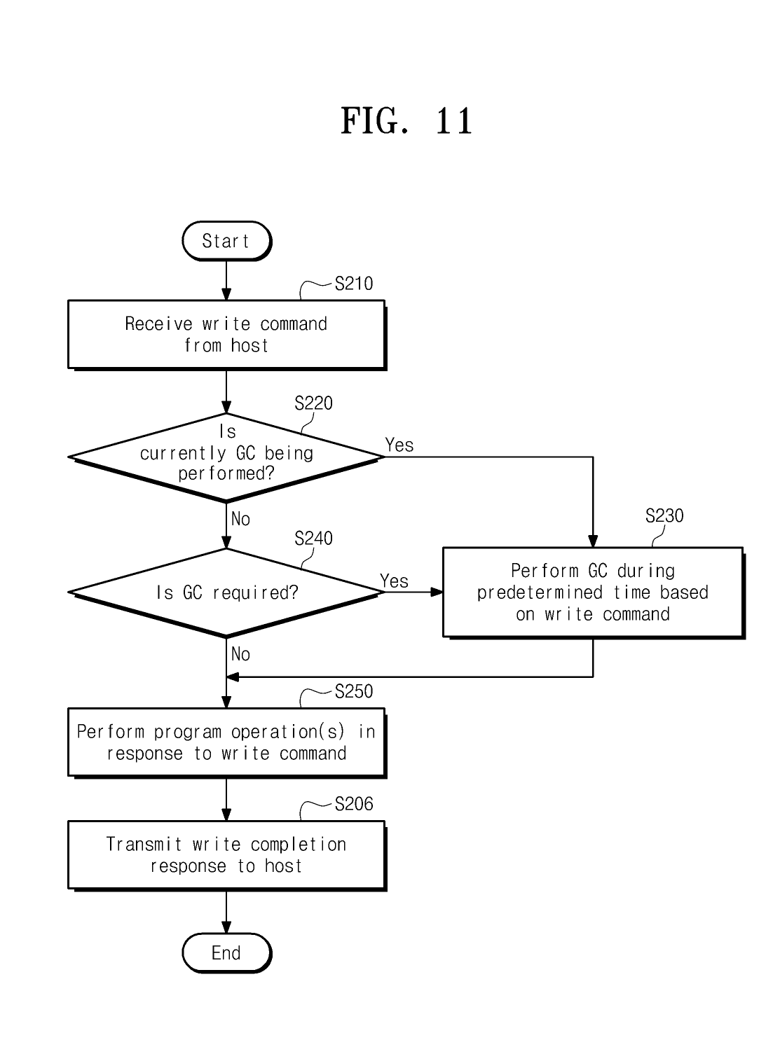

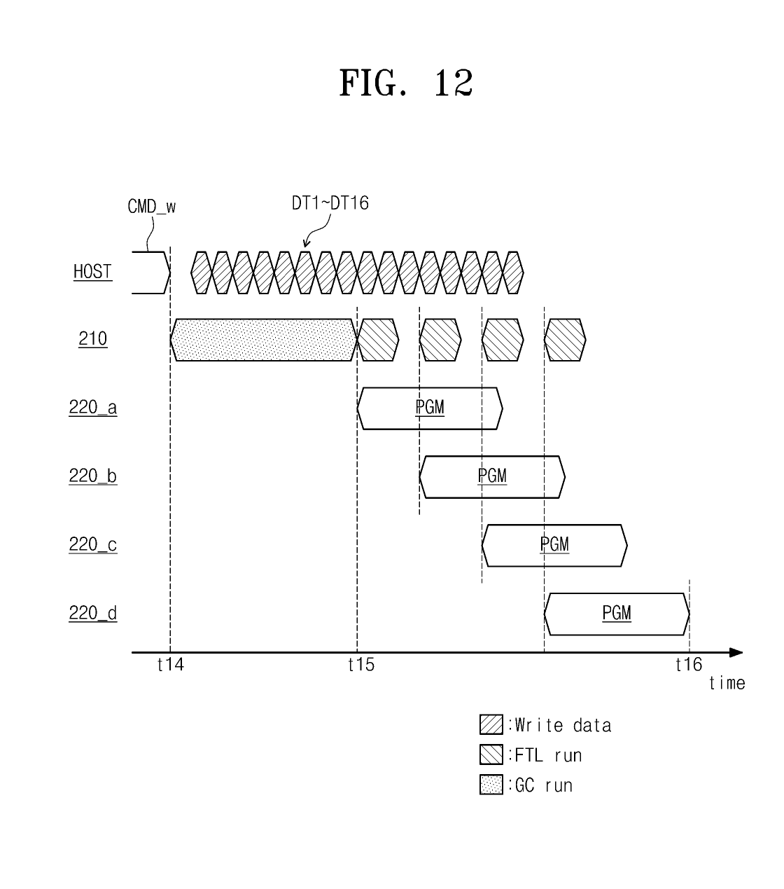

FIGS. 9 and 10 illustrate the operation of the nonvolatile memory system in FIG. 8. According to at least some example embodiments of the inventive concepts, the nonvolatile memory device 200 in FIG. 8 may operate according to the flowchart shown in FIG. 5.

Referring to FIGS. 8 and 9, a memory controller 210 may receive a write command CMD_w from a host at eighth time point t8. The write command CMD_w may be a command or a signal defined by an interface between the memory controller 210 and the host. The write command CMD_w may include information on a size of data to be written into first to fourth nonvolatile memory devices 220_a to 220_d.

At the eight time point t8, the memory controller 210 may determine whether garbage collection is currently being executed. As illustrated in FIG. 9, when the garbage collection is executed at the eighth time point t8, the memory controller 210 may continue to execute the garbage collection for execution time based on the write command CMD_w. For example, the memory controller 210 may further execute the garbage collection for a predetermined or, alternatively, desired time based on the information on a size of write data included in the write command CMD_w. According to at least some example embodiments of the inventive concepts, the memory controller 210 may receive write data from the host while executing the garbage collection. The received data may be temporarily stored in a buffer memory assigned to a host interface 116.

After executing the garbage collection for the predetermined or, alternatively, desired time, at a ninth time point t9, the memory controller 210 may perform a series of operations to write first to fourth write data DT1 to DT4 into the first nonvolatile memory device 220_a. For example, an FTL 211 of the memory controller may designate a physical area into which the first to fourth write data DT1 to DT4 are to be written and transmit the physical address of the designated area and the first to fourth data DT1 to DT4 to the first nonvolatile memory device 220_a. The first nonvolatile memory device 220_a may perform a program operation on the first to fourth write data DT1 to DT4 in response to received signals.

The memory controller 210 may perform a series of operations to write fifth to eighth data DT5 to DT8 into the second memory device 220_b while the first memory device 220_a performs a program operation on the first to fourth data DT1 to DT4. For example, the FTL 211 of the memory controller 210 may designate a physical area into which the fifth to eighth data DT5 to DT8 are to be written and transmit a physical address of the designated area and the fifth to eighth write data DT5 to DT8 to the second nonvolatile memory device 220_b. The second nonvolatile memory device 220_b may perform a program operation on the fifth to eighth write data DT1 to DT8 in response to received signals.

After the program operation on the first to eighth data DT1 to DT8 is completed, the memory controller 110 may transmit a write completion response to the host at tenth time point t10.

As described above, execution time of garbage collection is adjusted based on size information of write data included in a write command CMD_w to improve write performance of a nonvolatile memory system.

Referring to FIGS. 8 and 10, the memory controller 210 may receive the write command CMD_w from the host. According to at least some example embodiments of the inventive concepts, write data in FIG. 10 may be greater than the write data in FIG. 9. That is, timeout time of a write operation in FIG. 10 may be longer than the timeout time of the write operation in FIG. 9. In addition, a predetermined or, alternatively, desired time for executing the garbage collection in FIG. 10 may be longer than the predetermined or, alternatively, desired time for executing the garbage collection in FIG. 9.

The memory controller 210 may execute garbage collection for execution time based on the write command CMD_w. After executing the garbage collection for the execution time based on the write command CMD_w, at a twelfth time point t12, the memory controller 210 may perform a series of operations to sequentially write received write data DT1 to DT16 into the first to fourth nonvolatile memory devices 220_a to 220_d. The first to fourth nonvolatile memory devices 220_a to 220_d may sequentially perform a program operation under the control of the memory controller 210, respectively.

After the program operation performed on write data DT1 to DT16 are all completed, the memory controller 210 may transmit a write completion response to the host at thirteenth time point t13.

As described with reference to FIGS. 8 to 10, the nonvolatile memory system 200 may adjust execution time of a garbage collection that is being performed, according to a size of write data included in a received write command CMD_w. Accordingly, since the garbage collection need not be executed during a program operation of nonvolatile memory devices, interleaving for the write data is maintained. Thus, a nonvolatile memory system with improved performance is provided.

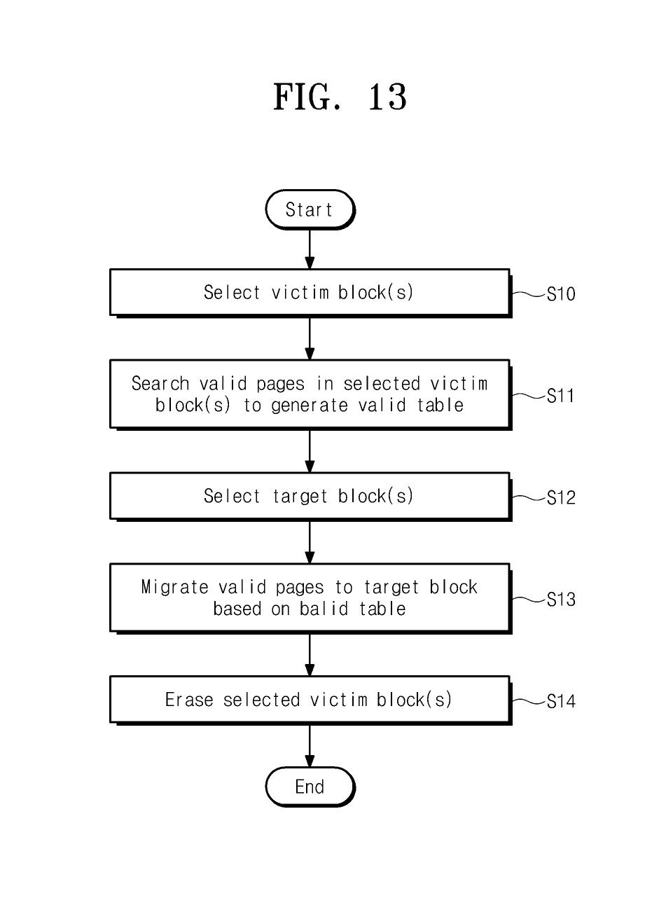

FIG. 11 is a flowchart showing an operation of a nonvolatile memory system according to at least some example embodiments of the inventive concepts. Referring to FIGS. 8 and 11, the memory controller 210 may perform steps S210 to S230. The steps S210, S220, and S230 may be the same as steps S110, S120, and S130 and will not be described in further detail.

When a result of the determination in the step S220 indicates that the memory controller 210 is not executing the garbage collection, in a step S240, the memory controller 210 may determine whether the garbage collection is required. For example, the memory controller 210 may determine whether the garbage collection is required based on the number of free blocks. When the number of the free blocks is smaller than a critical value, the memory controller 210 determines as the garbage collection is required.

When a result of the determination in the step S240 indicates that the garbage collection required, the memory controller 210 may perform the step S230. That is, that memory controller 210 may execute the garbage collection for a predetermined or, alternatively, desired time based on the received write command CMD_w.

Then, the memory controller 210 may perform steps S250 and S260. The steps S250 and 260 may be the same as steps S140 and S150 in FIG. 5, respectively and will not be described in further detail.

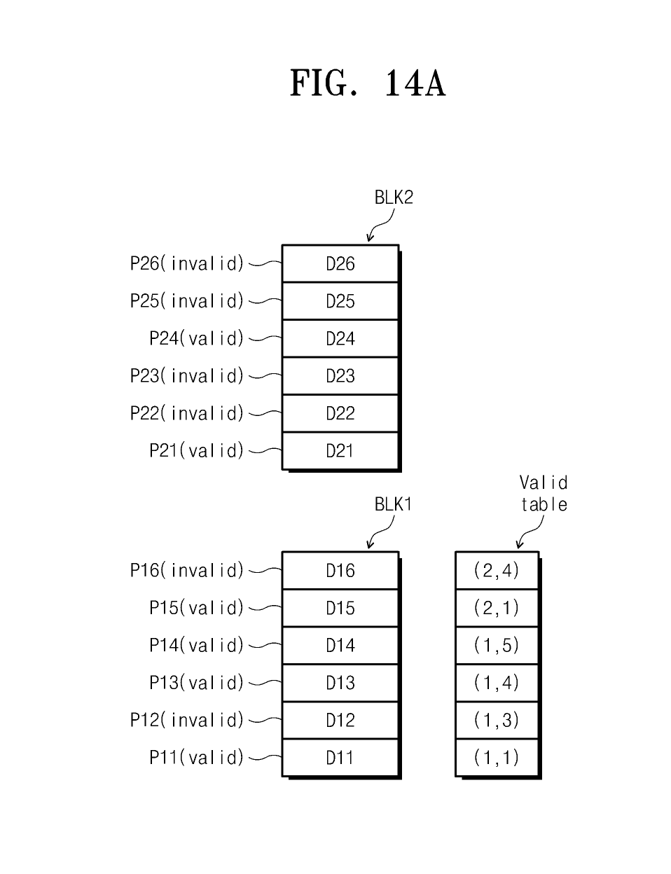

FIG. 12 is a timing diagram illustrating the operation of the nonvolatile memory system in FIG. 11. Referring to FIGS. 8, 11, and 12, at fourteenth time point t14, the memory controller 210 may receive a write command CMD_w from the host.

As shown in FIG. 12, the memory controller 210 may not be executing garbage collection immediately before the fourteenth time point t14. In this case, the memory controller 210 may determine whether the garbage collection is required.

As described with reference to the step S240 in FIG. 11, when the garbage collection is required, the memory controller 210 may execute the garbage collection for a predetermined or, alternatively, desired time based on the write command CMD_w. More specifically, the memory controller 210 may execute the garbage collection for a predetermined or, alternatively, desired time based on information on a size of write data included in the write command CMD_w.

After executing the garbage collection for the predetermined or, alternatively, desired time, the memory controller 210 may sequentially write the write data DT1 to DT16 received from the host into the first to fourth nonvolatile memory devices 220_a to 220_d at fifteenth time point t15.

After writing all the write data DT1 to DT16 into the first to fourth nonvolatile memory devices 220_a to 220_d, the memory controller 210 may transmit a write completion response to the host at sixteenth time point t16.

According to at least some of the above-described example embodiments of the inventive concepts, a nonvolatile memory system may receive a write command CMD_w from an external host (e.g., host) and adjust execution time of garbage collection based on the received write command CMD_w. Thus, write performance of the nonvolatile memory system is performed.

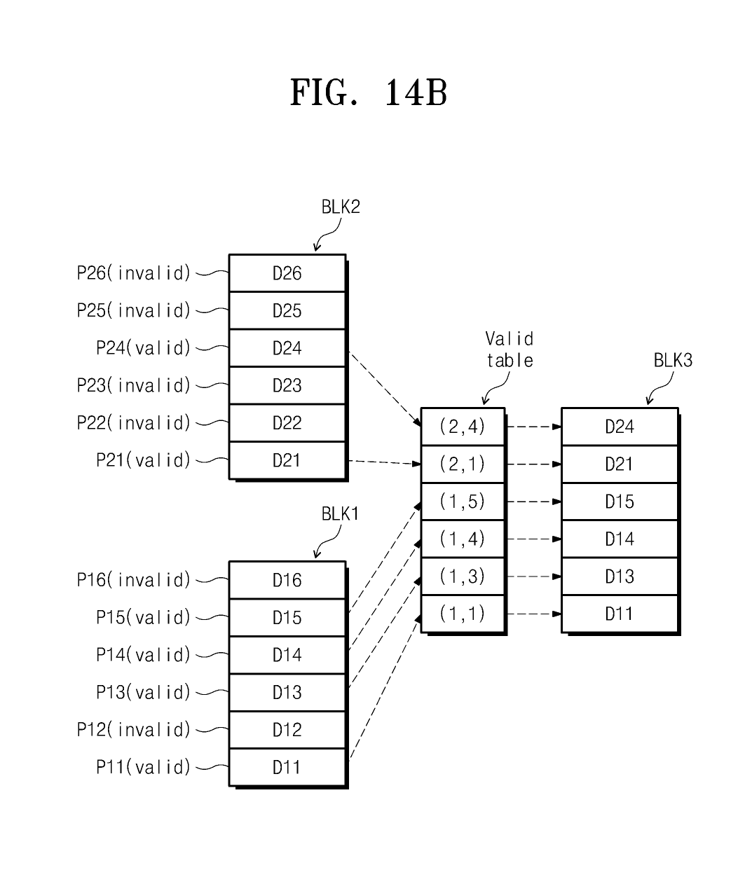

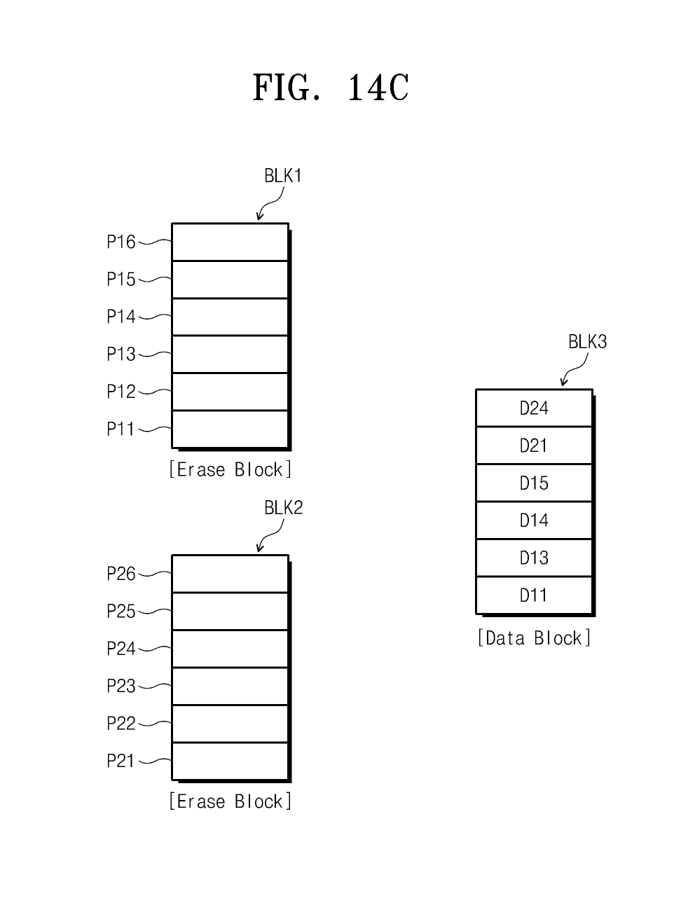

FIG. 13 is a flowchart summarizing a garbage collection operation of a nonvolatile memory system, and FIGS. 14A to 14C illustrate the garbage collection operation in FIG. 13.

According to at least some example embodiments of the inventive concepts, garbage collection described with reference to FIGS. 13 to 14C may be executed by an FTL 111 of a memory controller 110.

Referring to FIGS. 1 and 13, in step S10, the memory controller 110 may select at least one victim block. For example, the memory controller 110 may select at least one victim block among a plurality of memory blocks BLK1 to BLKn included in the nonvolatile memory device 120. For example, the memory controller 110 may select a block including the greatest number of invalid pages, among the memory blocks BLK1 to BLKn, as at least one victim block. However, example embodiments are not limited thereto and the memory controller 110 may select a victim block based on various conditions such as the number of invalid pages, the number of valid pages, program elapsed time, and a bit error rate of the memory blocks BLK1 to BLKn.

In step S11, the memory controller 110 may search valid pages of the selected at least one victim block to generate a valid table. For example, the memory controller 110 may search a valid page of the at least one victim block based on a mapping table or a spare area of the at least one victim block. The memory controller 110 may generate a valid table based on searched valid pages of the at least one victim block. The valid table includes information on valid pages of victim blocks (e.g., block number of a victim block, physical page number, etc.).

In step S12, the memory controller 110 may select a target block. For example, the memory controller 110 may select a target block among free blocks based on program/erase counts.

In step S13, the memory controller 110 may allow the valid page of the victim block to migrate to the target block based on the generated valid table. For example, the memory controller 110 may read data stored in the valid page of the victim block based on the valid table and write the read data into the target block.

In step S14, the memory controller 110 may erase the victim block. The erased victim block may be used as a free block.

Now, the garbage collection in FIG. 13 will be described in detail with reference to FIGS. 14A to 14C. For brevity of description, an example will be described where each of a plurality of memory blocks BLK1 to BLKn includes first to sixth pages, first and second memory blocks BLK1 and BLK2 are selected victim blocks, and a third memory block BLK3 is a target block. However, example embodiments are not limited thereto.

As shown in FIG. 14A, the memory controller 110 may select the first and second memory blocks BLK1 and BLK2 as victim blocks.

First to sixth pages P11 to P16 of the first memory block BLK1 may store data D11 to D16, respectively. In this case, first, third, fourth, and fifth pages P11, P13, P14, and P15 may be valid pages while second and sixth pages P12 and P16 may be invalid pages. That is, the data D11, D13, D14, and D15 stored in the first, third, fourth, and fifth pages P11, P13, P14, and P15 of the first memory block BLK1 are valid data while the data D12 and D15 stored in the second and sixth pages P12 and P16 may be invalid data.

First to sixth pages P21 to P26 of the second memory block BLK2 may store data D21 to D26, respectively. In this case, first and fourth pages P21 and P24 may be valid pages while second, third, fifth, and sixth pages P22, P23, P25, and P26 may be invalid pages. That is, data D21 and D24 stored in the first and fourth pages P21 and P24 may be valid data while data D22, D23, D25, and D26 stored in the second, third, fifth, and sixth pages P22, P23, P25, and P26 may be invalid data.

The memory controller 110 may search valid pages of the first and second memory blocks BLK1 and BLK2 based on a mapping table for the first and second memory blocks BLK1 and BLK2 to generate a valid table. The valid table may include a block number of a victim block and a page number of a valid page.

According to at least some example embodiments of the inventive concepts, the memory controller 110 may scan a spare area of a plurality of pages of the first and second memory blocks BLK1 and BLK2 to determine whether each of the pages is a valid page or an invalid page and thus may generate a valid table.

As shown in FIG. 14B, the memory controller 110 may sequentially read data stored in pages included in the generated valid table and sequentially write the read data into the third memory block BLK3 that is a target block. For example, the memory controller 110 may read the data D11 stored in the first page P11 of the first memory block BLK1 and write the read data D11 in the third memory block BLK3. Then, the memory controller 110 may read the data D13 stored in third page P13 of the first memory block BLK1 and write the read data D13 into the third memory block BLK3. That is, the memory controller 110 may write data of valid pages of the victim blocks into a target block after reading the data of the valid pages in one or more page units. According to at least some example embodiments of the inventive concepts, the memory controller 110 may repeatedly perform read and write operations of the above-mentioned one or more page units until all the valid pages of the victim block are migrated.

After writing all valid data (i.e., all data stored in a valid page) of the first memory block BLK1 into the third memory block BLK3, the memory controller 110 may allow valid data of the second memory block BLK2 to be migrated to the third memory block BLK3.

According to at least some example embodiments of the inventive concepts, the memory controller 110 may allow valid data to be migrated in units of pages, sub-blocks or blocks.

As shown in FIG. 14C, after all valid data of the first and second blocks BLK1 and BLK2 migrate to a target block BLK3, the memory controller 110 may erase the victim blocks BLK1 and BLK2. The erased victim blocks BLK1 and BLK2 may be used as free blocks.

According to at least some example embodiments of the inventive concepts, according to the operating method of a nonvolatile memory system described with reference to FIGS. 1 to 12, execution time of garbage collection is adjusted based on a write command. According to at least some example embodiments of the inventive concepts, a nonvolatile memory system may adjust the operation steps of garbage collection described with reference to FIGS. 13 to 14C instead of execution time of the garbage collection.

For example, as describe with reference to FIGS. 13 to 14C, the garbage collection may include a plurality of operations such as a victim block selecting operation, a bitmap table generating operation, a target block selecting block, a valid page migrating operation, and a victim block erasing operation. When the memory controller 110 perform garbage collection after receiving a write command CMD_w, the memory controller 110 or 210 may perform some of the plurality of operations of the garbage collection based on the write command CMD_w. That is, execution time of the garbage collection may be adjusted according to information on a size of write data included in the write command CMD_w. The memory controller 110 may select operations that can be performed within the adjusted execution time and perform the selected operations.

In further detailed example embodiments, performing operations within the predetermined or, alternatively, desired time may include a victim block selecting operation, a bitmap table generating operation, a target block selecting operation, and a valid page migrating operation. In this case, the memory controller 110 may perform the victim block selecting operation, the bitmap table generating operation, the target block selecting operation, and the valid page migrating operation and store information on the performed operations in a separate storage circuit or an SRAM 113 (see FIG. 3).

Then, when the memory controller 110 executes the garbage collection, the memory controller 110 may perform subsequent operations (e.g., a victim block erasing operation, etc.) with reference to the stored information on the performed operations.

The operations of garbage collection are merely examples, and operations for executing the garbage collection may be subdivided. For example, the valid page migrating operation may be subdivided into migrating operations for each of a plurality of valid pages.

According to the above-described example embodiments, a nonvolatile memory system may adjust execution time (or execution step) of garbage collection based on a write command received from an external device. Thus, timeout time for the write command is satisfied and interleaving for write data is maintained to improve write performance of the nonvolatile memory system.

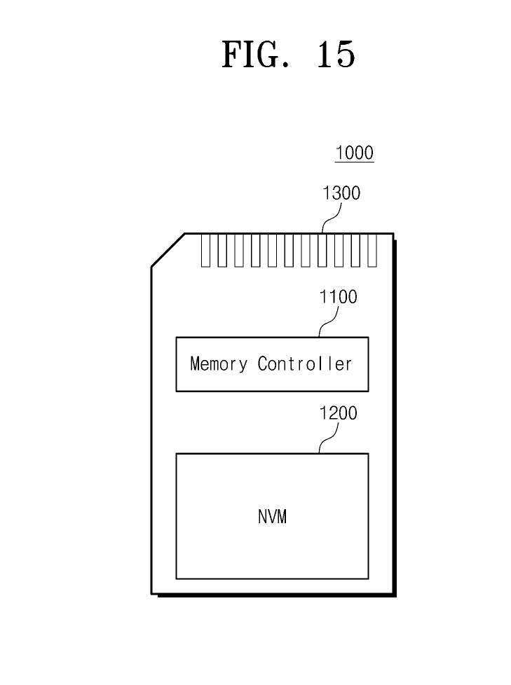

FIG. 15 is a block diagram schematically illustrating a memory card system including a nonvolatile memory system according to at least some example embodiments of the inventive concepts. Referring to FIG. 15, a memory card system 1000 contains a memory controller 1100, a nonvolatile memory 2200, and a connector 1300.

The memory controller 1100 is connected to the nonvolatile memory 1200. The memory controller 1100 is configured to access the nonvolatile memory 1200. For example, the memory controller 1100 may be adapted to control an overall operation of the nonvolatile memory 1200 including, but not limited to, a read operation, a write operation, an erase operation, and a background operation. The memory controller 1100 provides an interface between the nonvolatile memory 1200 and a host. The memory controller 1100 is configured to drive firmware for controlling the nonvolatile memory 1200.

In at least some example embodiments of the inventive concepts, the memory controller 1100 may include components such as, but not limited to, a RAM, a processing unit, a host interface, a memory interface, and an error correction unit.

The memory controller 1100 communicates with an external device through the connector 1300. The memory controller 1100 communicates with an external device according to a particular communication protocol. For example, the memory controller 2100 may communicate with the external device through at least one of various interface protocols such as, but not limited to, universal serial bus (USB, multimedia card (MMC), eMMC (embedded MMC), peripheral component interconnection (PCI), PCI-express (PCI-E), advanced technology attachment (ATA), a serial-ATA protocol, parallel-ATA, small computer small interface (SCSI), enhanced small disk interface (ESDI), integrated drive electronics (IDE), UFS (Universal Flash Storage), WiFi, Bluetooth, NVMe, and Firewire.

According to at least some example embodiments of the inventive concepts, a write command defined by the above-mentioned communication standards may include size information of write data. According to at least some example embodiments of the inventive concepts, the controller 1100 may the operation described with reference to FIGS. 1 to 14.

In at least some example embodiments of the inventive concepts, the nonvolatile memory 1200 may be implemented with a variety of nonvolatile memory devices, such as, but not limited to, an EPROM (Electrically Erasable and Programmable ROM), a NAND flash memory, a NOR flash memory, a PRAM (Phase-change RAM), an ReRAM (Resistive RAM), a FRAM (Ferroelectric RAM), and an STT-MRAM (Spin-Torque Magnetic RAM).

In at least some example embodiments of the inventive concepts, the memory controller 1100 and the nonvolatile memory 1200 may be integrated in a single semiconductor device. The memory controller 1100 and the nonvolatile memory 1200 may be integrated in a single semiconductor device to form a solid state drive (SSD). The memory controller 1100 and the nonvolatile memory 1200 may be integrated in a single semiconductor device to form a memory card such as, but not limited to, a PC card (PCMCIA, personal computer memory card international association), a compact flash card (CF), a smart media card (SM, SMC), a memory stick, a multimedia card (MMC, RS-MMC, MMCmicro), an SD card (SD, miniSD, microSD, SDHC), and a universal flash storage

The nonvolatile memory 1200 or the memory card system 1000 may be packaged according to any of a variety of different packaging technologies. Examples of such packaging technologies may include the following: PoP (Package on Package), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), and Wafer-Level Processed Stack Package (WSP).

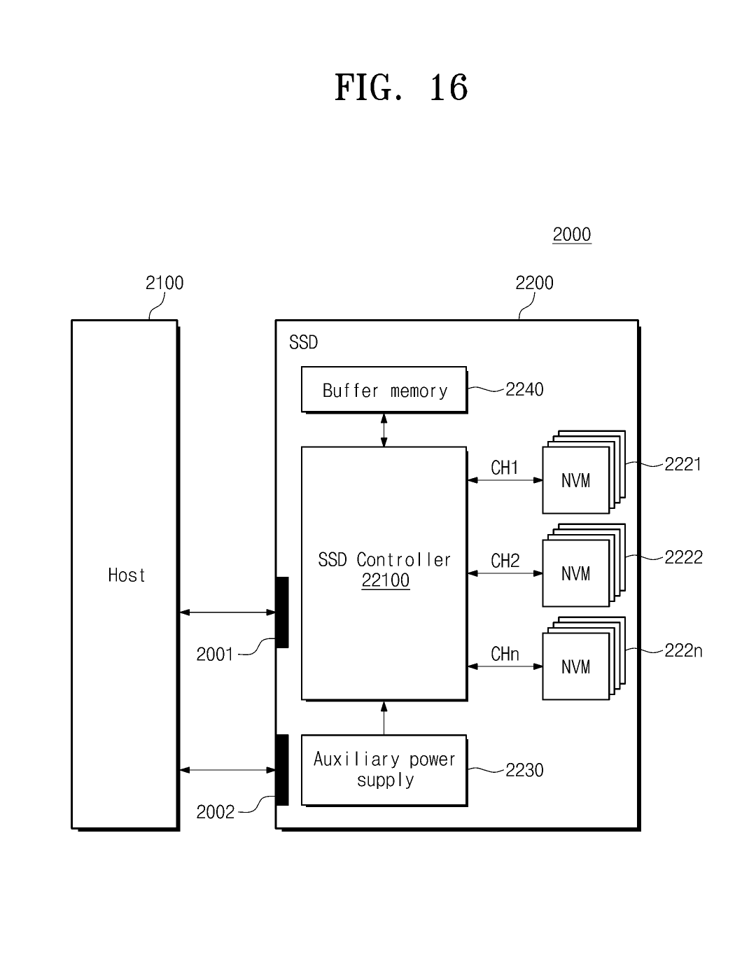

FIG. 16 is a block diagram illustrating a solid state drive including a nonvolatile memory system according to at least some example embodiments of the inventive concepts. Referring to FIG. 16, a solid state drive (SSD) system 2000 comprises a host 2100 and an SSD 2200. The SSD 2200 exchanges signals SGL with the host 2100 through the host interface 2001 and is supplied with a power through a power connector 2002. The SSD 2200 comprises a plurality of flash memories 2221 to 222n, an SSD controller 2210, an auxiliary power supply 2230, and a buffer memory 2240.

The SSD controller 2210 may control the flash memories 2221 to 222n in response to the signal SIG received from the host 2100. According to at least some example embodiments of the inventive concepts, the SSD controller 2210 may operate based on the operating method described with reference to FIGS. 1 to 14.

The auxiliary power supply 2230 is connected to the host 2100 via the power connector 2002. The auxiliary power supply 2230 is charged by a power PWR from the host 2100. When a power is not smoothly supplied from the host 2100, the auxiliary power supply 2230 powers the SSD system 2000. The auxiliary power supply 2230 may be placed inside or outside the SSD 2200. For example, the auxiliary power supply 2230 may be put on a main board to supply an auxiliary power to the SSD 2200.

The buffer memory 2240 acts as a buffer memory of the SSD 2200. For example, the buffer memory 2240 temporarily stores data received from the host 2100 or from the flash memories 2221 to 222n, or it temporarily stores metadata (e.g., mapping tables) of the flash memories 2221 to 222n. The buffer memory 2240 may include volatile memories such as DRAM, SDRAM, DDR SDRAM, LPDDR SDRAM, and SRAM or nonvolatile memories such as FRAM ReRAM, STT-MRAM, and PRAM.

In at least some example embodiments of the inventive concepts, the SSD controller 2210 may read data stored at the flash memories 2221 through 222n based on an operating method described with reference to FIGS. 1 through 15. In at least some example embodiments of the inventive concepts, a read managing unit and a read history table described with reference to FIGS. 1 through 15 may be stored at the buffer memory 2240 and may be driven by the SSD controller 2210. Alternatively, a read managing unit and a read history table described with reference to FIGS. 1 through 15 may be stored and driven at a cache memory (not shown) of the SSD controller 2210.

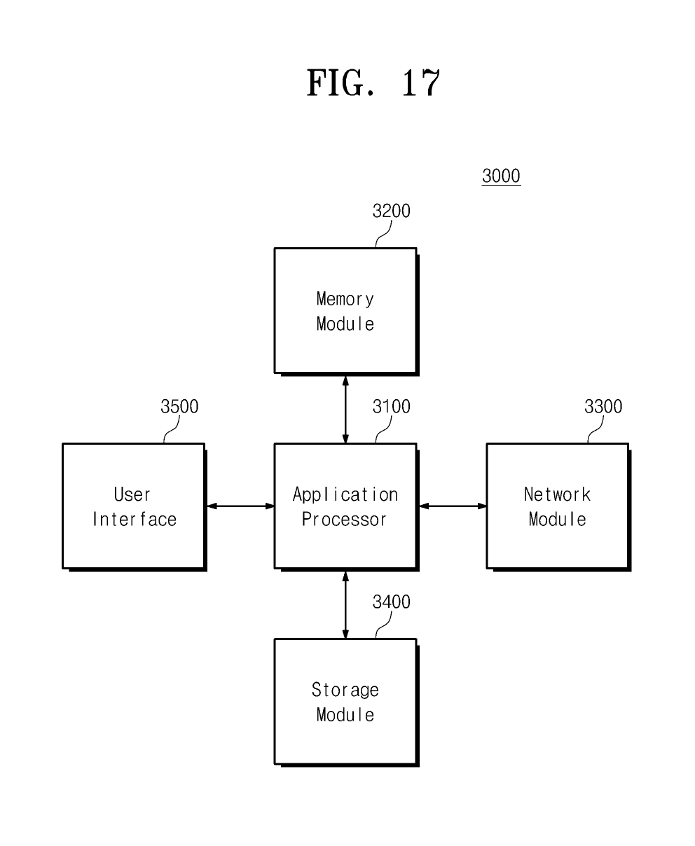

FIG. 17 is a block diagram schematically illustrating a user system including a nonvolatile memory system according to at least one example embodiment of the inventive concepts. Referring to FIG. 17, a user system 3000 includes an application processor 3100, a memory module 3200, a network module 3300, a storage module 3400, and a user interface 3500.

The application processor 3100 drives components of the user system 3000, an operating system, and so on. For example, the application processor 3100 may include controllers for controlling components of the user system 3000, graphics engines, a variety of interfaces, and so on. The application processor 3100 may be implemented with a system-on-chip (SoC).

The memory module 3200 operates as a main memory, a working memory, a buffer memory, or a cache memory of the user system 3000. The memory module 3200 may be implemented with a volatile random access memory, such as DRAM (Dynamic Random Access Memory), SDRAM (Synchronous DRAM), DDR SDRAM (Double Date Rate SDRAM), DDR2 SDRAM, DDR3 SDRAM, LPDDR DRAM, LPDDR2 DRAM, or LPDDR3 DRAM or a nonvolatile random access memory, such as PRAM (Phase-change RAM), MRAM (Magnetic RAM), RRAM (Resistive RAM), or FRAM (Ferroelectric RAM). In at least some example embodiments of the inventive concepts, the application processor 3100 and the memory module 3200 are packed in a semiconductor package depending on the POP (Package on Package).

The network module 3300 communicates with external devices. For example, the network module 3300 may support wireless communications, such as CDMA (Code Division Multiple Access), GSM (Global System for Mobile communication), WCDMA (wideband CDMA), CDMA-2000, TDMA (Time Division Multiple Access), LTE (Long Term Evolution), Wimax, WLAN, UWB, Bluetooth, WI-DI, and so on. As another embodiment, the network module 3300 may be embedded in the application processor 3100.

The storage module 3400 stores data. For example, the storage module 3400 stores data received from the application processor 3100. Alternatively, the storage module 3400 provides the application processor 3100 with data stored therein. For example, the storage module 3400 may be implemented with a nonvolatile semiconductor memory device such as PRAM, MRAM, RRAM, NAND flash memory, NOR flash memory, or a three-dimensional NAND flash memory.

According to at least some example embodiments of the inventive concepts, the storage module 3400 may operate based on the operating method described with reference to FIGS. 1 to 14. The storage module 3400 may communicate with the application processor 3100 based on a predetermined interface. The storage module 3400 may adjust execution time of garbage collection based on a write command received from the application processor 3100.

The user interface 3500 may provide interfaces for providing data or commands to the application processor 3100 or for outputting data to an external device. For example, the input interface 3500 may include user input interfaces, such as a key board, a key pad, a button, a touch panel, a touch screen, a touch pad, a touch ball, a camera, a microphone, a Gyroscope, a vibration sensor, and a piezoelectric element. The input interface 3500 may include user output interfaces, such as an LCD (Liquid Crystal Display) device, an OLED (Organic Light Emitting Diode) display device, an AMOLED (Active Matrix OLED) display device, an LED, a speaker, and a motor.

According to the above-described example embodiments, a nonvolatile memory system may adjust execution time (or execution step) of garbage collection based on a write command received from an external device. Thus, timeout time for the write command is satisfied and data interleaving is maintained because garbage collection is not performed during a program operation of nonvolatile memory devices. As a result, a nonvolatile memory system with improved performance and an operating method of the nonvolatile system may be provided.

Example embodiments of the inventive concepts having thus been described, it will be obvious that the same may be varied in many ways. Such variations are not to be regarded as a departure from the intended spirit and scope of example embodiments of the inventive concepts, and all such modifications as would be obvious to one skilled in the art are intended to be included within the scope of the following claims.

What is claimed is:

1. An operation method of a nonvolatile memory system including a nonvolatile memory and a memory controller configured to control the nonvolatile memory, the operating method comprising:
receiving a write command including size information indicating a size of write data from an external device;
determining whether or not garbage collection is being executed;
executing the garbage collection for a first period of time based on the size information according to a result of the determination; and
programming the write data into the nonvolatile memory after executing the garbage collection.

2. The operation method as set forth in claim 1, further comprising:
transmitting a write completion response to the external device after the programming of the write data is completed.

3. The operation method as set forth in claim 1, further comprising:
setting the first period of time such that the first period of time increases as the size of the write data increases.

4. The operation method as set forth in claim 3, wherein
the setting includes determining a length of the first period of time based on timeout time for the write command and a program time of the write data.

5. The operation method as set forth in claim 4, wherein
the timeout time indicates a time defined by an interface between the external device and the memory controller, and
the program time indicates a length of time of a programming operation for programming the write data into the nonvolatile memory.

6. The operation method as set forth in claim 1, wherein the executing the garbage collection comprises:
continuing to execute the garbage collection for the first period of time when the result of the determination indicates that the garbage collection is being executed.

7. The operating method as set forth in claim 1, wherein the executing the garbage collection comprises:
determining whether criteria for performing the garbage collection are met when the result of the determination indicates that the garbage collection is not being executed; and
executing the garbage collection for the first period of time when the criteria are determined to be met.

8. The operating method as set forth in claim 7, wherein the determining whether the criteria for performing the garbage collection are met comprises:
determining whether a number of free blocks among a plurality of memory blocks included in the nonvolatile memory is smaller than a threshold value.

9. The operating method as set forth in claim 1, wherein the garbage collection includes a plurality of operations, and
the executing the garbage collection for the first period of time includes performing some of the plurality of operations of the garbage collection according to the result of the determination.

10. The operating method as set forth in claim 9, wherein the plurality of operations comprises:
selecting at least one victim block among a plurality of memory blocks of the nonvolatile memory;
identifying one or more valid pages among a plurality of pages included in the selected at least one victim block to generate a valid table;
selecting a target block among the plurality of memory blocks;
moving data of the one or more valid pages to the target block based on the valid table; and
erasing the selected at least one victim block.

11. The operating method as set forth in claim 1, wherein the receiving the write command comprises:
receiving the write command and the write data, and
at least some of the write data is during the first period of time.

12. A nonvolatile memory system comprising:
a nonvolatile memory including a plurality of memory blocks; and
a memory controller configured to receive a write command including write data and size information of the write data from an external device, program the received write data into the nonvolatile memory, determine whether garbage collection is being executed when the write command is received, and execute the garbage collection based on the size information according to a result of the determination.

13. The nonvolatile memory system as set forth in claim 12, wherein
the memory controller programs the received write data into the nonvolatile memory after executing the garbage collection.

14. The nonvolatile memory system as set forth in claim 13, wherein
the memory controller transmits a write completion response to the external device after programming all the received write data.

15. The nonvolatile memory system as set forth in claim 12, wherein
the memory controller does not execute the garbage collection while programming the write data into the nonvolatile memory.

16. The nonvolatile memory system as set forth in claim 12, wherein
the memory controller executes the garbage collection for the predetermined time while receiving the write data.

17. The nonvolatile memory system as set forth in claim 12, wherein
the predetermined time increases as a size of the write data increases.

18. The nonvolatile memory system as set forth in claim 12, wherein
the garbage collection comprises:
an operation of selecting a victim block among a plurality of memory blocks included in the nonvolatile memory device by the memory controller;
an operation of generating a valid table based on a valid page of the selected victim block by the memory controller;
an operation of selecting a target block among the plurality of memory blocks by the memory controller;
an operation of allowing data of the valid page of the victim block to migrate to the target block based on the generated valid table by the memory controller; and
an operation of erasing the victim block by the memory controller, and
the memory controller performs some of a plurality of operations included in the garbage collection for time according to the write command.

19. The nonvolatile memory system as set forth in claim 12, wherein
the memory controller transmits a device response to the external device in response to the write command to receive the write data from the external device.
